(19) United States
(12) Patent Application Publication
(10) Pub. No.: US 2007/0044846 A1
(43) Pub. Date: Mar. 1, 2007

(54) Check valve

(75) Inventors: Mark Ashurst, Shingle Springs, CA (US); Thomas B. Martin SR., Cameron Park, CA (US)

Correspondence Address: Thomas B. Martin SR., 4305 Business Drive, Cameron Park, CA, 95682, US

(73) Assignee: Transportation Research Corp.

(21) Appl. No.: 11/510,291

(22) Filed: Aug. 25, 2006

Related U.S. Application Data
(60) Provisional application No. 60/711,951, filed on Aug. 25, 2005.

(51) Int. Cl. F16K 15/00

(52) U.S. Cl. 137/513.3; 137/533.13

(57) ABSTRACT

Described is a check valve with a housing having an inlet side and an outlet side, a flow blocking valve element with centering protrusions, an inlet annular shoulder, an outlet annular shoulder, cylindrical valve element cavity with an aspect ratio such that the flow blocking valve element cannot be put in a position where it is jammed. The centering protrusions on the flow blocking valve element support it on the outlet annular shoulder and allow flow to pass between the central disc of the valve element and the larger diameter of the outlet orifice. When flow is attempted in the inhibited direction, the flow blocking valve element is pressed against the inlet annular shoulder, forming a seal and blocking the flow. The valve has the advantage of being inexpensive to manufacture and highly reliable.

### BACKGROUND OF THE INVENTION

1. Field of the Invention

The field of the invention is in check valves, valves that allow flow in one direction but not in the other. Particularly, the invention relates to check valves designed for low cost manufacturing and high reliability operation.

2. Description of Related Art

Check valves are used when flow is needed in one direction in a system but must be blocked from the other direction.

Check valves typically operate by blocking the flow of liquid with a movable flow-blocking element, such as a ball, a piston, or a plate, or a more complex valve element.

The problem with current check valve technology is that the valves are complex and expensive. Also, they may be constructed from a relatively large number of parts, and if the valve fails, pieces of the valve may be swept through the valve and into other parts of the system, causing further difficulties.

Particularly for applications such as a check valve in a diesel lubrication oil pumping system, the valve must be inexpensive and highly reliable. If the valve were to malfunction and break apart, pieces of the valve could be swept into the rest of the system and cause additional more difficult to repair damage.

The problem with existing check valves are that they are complex and expensive to manufacture.

What is needed is a check valve that is highly manufacturable at low cost, very reliable, and does not allow large pieces to pass out of the valve in the event of a failure.

### SUMMARY OF THE INVENTION

The invention comprises a housing assembly with an inlet side and an outlet side, a inlet annular shoulder, a flow blocking valve element with centering protrusions, a flow blocking plate cavity with a cylindrical wall, a flow inlet, a flow outlet, and an outlet annular shoulder.

The flow blocking valve element with centering protrusions is pushed against the inlet annular shoulder when flow is attempted in the inhibited direction. The flow blocking element makes a seal with the inlet annular shoulder, preventing flow in the inhibited direction.

When the flow is in the allowed direction, the centering protrusions of flow blocking valve element rest against the outlet annular shoulder and flow passes around the flow blocking valve element central disc from the inlet to the outlet.

The cavity that holds the flow blocking valve element is shaped such that the flow blocking valve element cannot become jammed but is always free to move in response to the flow through the valve. This is accomplished by ensuring that the contact points between the flow blocking valve element and the halves of the housing have low friction in the axial direction, and is sized so the flow blocking valve element cannot become wedged or jammed in the flow blocking plate cavity.

The valve does not have a spring to hold the flow blocking plate against the annular shoulder, or any additional components required to keep the flow blocking valve element aligned or centered. This results in a design that is inexpensive to manufacture. It also results in a valve that has the advantage of being very durable and reliable and unlikely to break in such a way that allows large pieces of debris to be swept downstream into the system to which the module is attached.

### SHORT DESCRIPTION OF DRAWINGS

FIG. 1 is a pictorial cut-away view of the check valve of the present invention.

FIG. 2 is a cross section view of the cylindrical valve element cavity of the check valve of the present invention.

FIG. 3 is a top view of the flow-blocking plate of the present invention.

FIG. 4 is a cross section view of the check valve of the present invention with flow in the allowed direction.

FIG. 5 is a cross section view of the check valve of the present invention with flow blocked by the flow blocking valve element.

FIG. 6 is a schematic diagram of the check valve of the present invention integrated into a locomotive engine lubrication system.

FIG. 7 is an external oblique view of the check valve of the present invention.

### DETAILED DESCRIPTION OF THE INVENTION

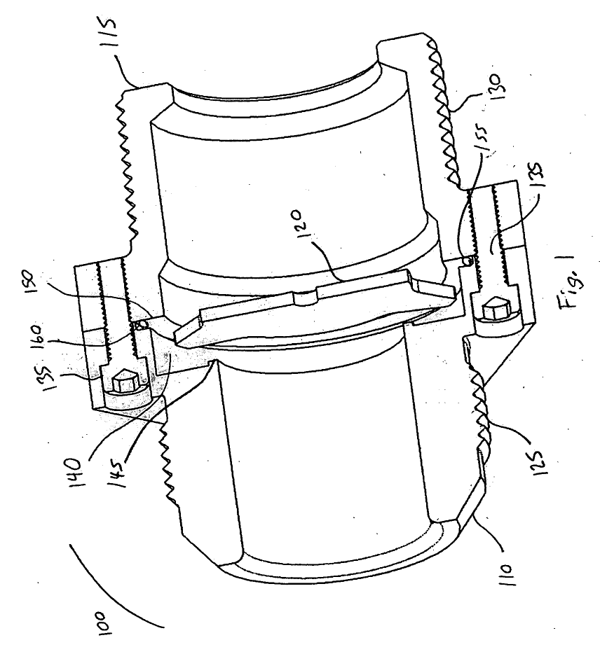

FIG. 1 is a pictorial cut-away view of the check valve of the present invention. As depicted, the check valve (100) includes an inlet-side housing (110), an outlet-side housing (115), a flow blocking valve element (120), inlet threads (125), outlet threads (130), two assembly bolts (135), a cylindrical valve element cavity (140), an inlet annular shoulder (145), an outlet annular shoulder (150), an O-ring cavity (155), and an O-ring (160). The flow blocking valve element (120) is unattached to the remainder of the assembly and is free to move about within the cylindrical valve element cavity depending on the flow of fluid in the valve at any instant. During operation in the non-inhibited flow direction, flow enters the valve on the inlet side, flows around the central disc of the flow blocking valve element (120) to the outlet side while the centering protrusions of the flow blocking valve element (120) rest on edges of the outlet annular shoulder (150). When the pressure on the outlet side is higher then on the inlet side, the flow blocking valve element (120) is pressed against the inlet annular shoulder (145), blocking flow through the valve in the inhibited or flow-checked direction. The assembly bolts (135), two of which are shown in the cross section out of a total of six, hold the two housing halves together. The inlet threads (125) and outlet threads (130) are utilized to attach the valve to the rest of the system. Any type of standard connection method could be used here, i.e., inner threads, outer threads, or something else. The inlet side has a small diameter neck at the end of the valve to prevent large parts of the flow blocking valve element (120) from passing out of the valve into the rest of the system in the unlikely event that the flow blocking valve element (120) breaks apart during operation.

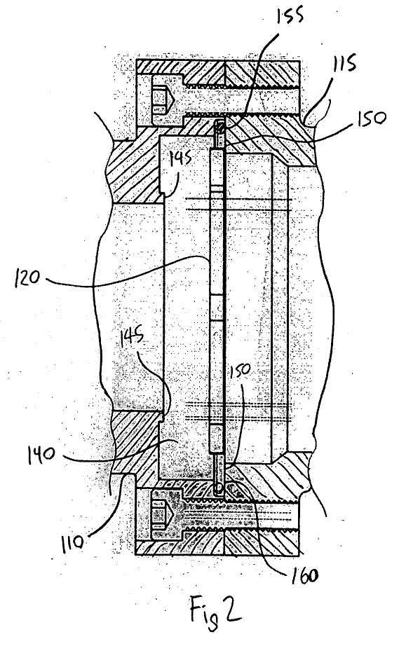

FIG. 2 is a cross section view of the cylindrical valve element cavity of the check valve of the present invention. As depicted, the cylindrical valve element cavity is formed within the inlet-side housing (110) and outlet-side housing (115), and includes a flow blocking valve element (120), an outlet annular shoulder (145) and an inlet annular shoulder (150). Also shown is the O-ring cavity (155) and an O-ring (160). The cylindrical section is designed to house the flow blocking valve element (120) in a way that makes it impossible to jam. The outer diameter of the flow blocking valve element (120) centering protrusions is less than the inner diameter of the cylindrical section by a factor of about 0.5%. In one embodiment, the thickness of the flow blocking valve element (120) is between 15% and 20% of the length of the cylindrical valve element cavity (140). The thickness of the flow blocking valve element (120) is also larger than the thickness of the O-ring enclosure. This prevents the edges of the centering protrusions on the flow blocking valve element (120) from catching on the upper edge of the O-ring enclosure. The inner diameter of the outlet orifice is small enough that at maximum tilt the edges of the flow blocking valve element (120) rest on flat area on top of the outlet annular shoulder (150) and do not reach the edge. This prevents the flow blocking valve element (120) from becoming wedged in place, since its edges always rest on a smooth surface. In one embodiment, the inlet annular shoulder has a small raised rim. This rim forms a seal between the flow blocking valve element (120) and the shoulder and concentrates the force on the flow blocking valve element (120) in a smaller area that it would if the valve element centering protrusions rested against the flat portion of the inlet annular shoulder (145). It also prevents bits of debris in the working fluid that are smaller than the height of the rim to prevent the flow blocking valve element (120) from seating against the inlet annular shoulder (145).

The flow blocking valve element (120) may rest on the inlet annular shoulder (145) or the outlet annular shoulder (150), depending on the pressures on the inlet side and the outlet side of the valve. When the pressure is higher on the outlet side, the flow blocking valve element (120) is pressed against the inlet annular shoulder (145), forming a seal and blocking flow from the outlet to the inlet. The flow blocking valve element (120) forms a circular seal with the rim on the inlet annular shoulder (145). When the pressure on the inlet side exceeds the pressure on the outlet side, the centering protrusions on the flow blocking valve element (120) rests against the outlet annular shoulder (150), and the working fluid is allowed to flow around the central disc of the flow blocking valve element (120), in the gap between the central core of the flow blocking valve element (120) and the inner diameter of the outlet annular shoulder (150) to the outlet side. By blocking flow in the one direction and not in the other, the valve operates as a check valve.

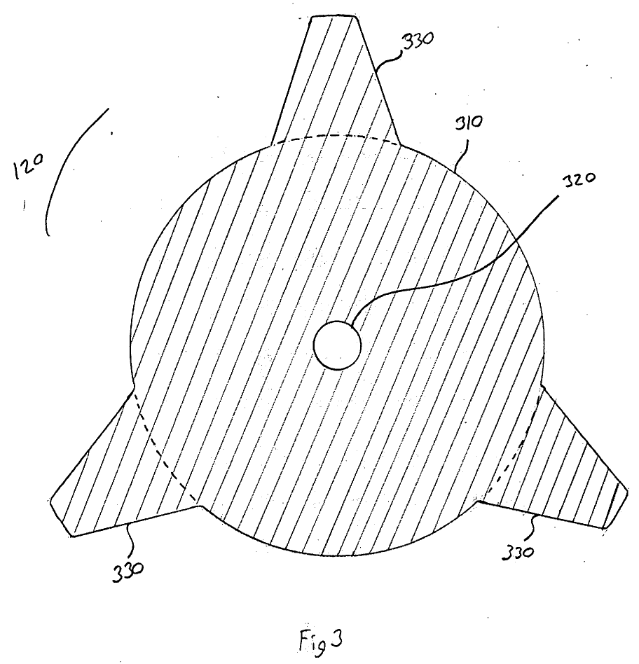

FIG. 3 is a top view of the flow blocking valve element of the present invention. As depicted, the flow blocking valve element (120) of the present invention includes a valve element central disc (310), a reverse flow orifice (320), three valve element centering protrusions (330). The valve element centering protrusions (330) serve to keep the flow blocking valve element (120) centered in the cylindrical valve element cavity (140) so it can cover the inlet annular shoulder (145) when the pressure on the outlet side is higher than the pressure on the inlet side. When the flow blocking valve element (120) is pushed against the outlet annular shoulder (150), the valve element centering protrusions (330) support the flow blocking valve element (120) and allow flow to go around the edge of the valve element central disc from the inlet side to the outlet side.

In one embodiment, the flow blocking valve element (120) is fabricated from cut from sheet steel using a laser cutting system. In another embodiment, the flow blocking valve element (120) is laser cut from sheet steel then deburred in a tumbled deburring apparatus to smooth the corners and edges. In another embodiment, the flow blocking valve element (120) is machined using standard machine tools. In another embodiment, the edges of the flow blocking valve element (120) are cut with a radius cutter to make them rounded.

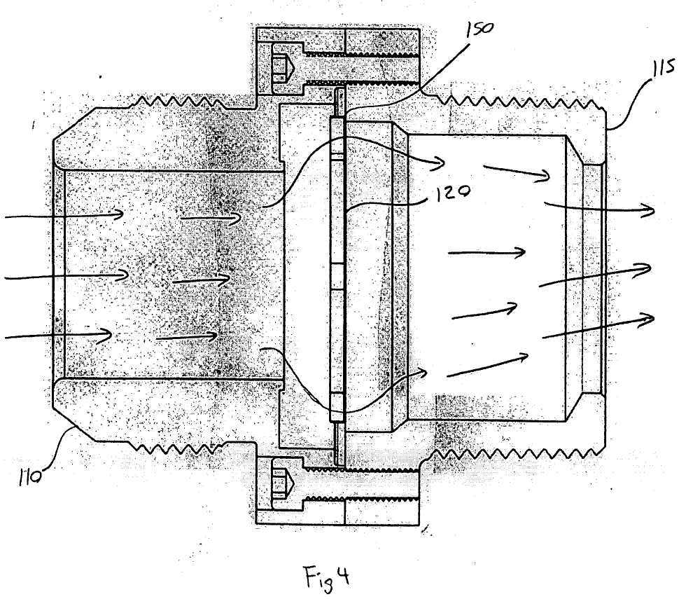

FIG. 4 is a cross section view of the check valve of the present invention with flow in the allowed direction. As depicted, the check valve includes the inlet side housing (110), the outlet side housing (115), and the flow blocking valve element (120). The flow blocking valve element (120) is shown against the outlet annular shoulder (150), and flow is indicated by arrows and is flowing around the central disc of the flow blocking valve element (120) from the inlet side to the outlet side.

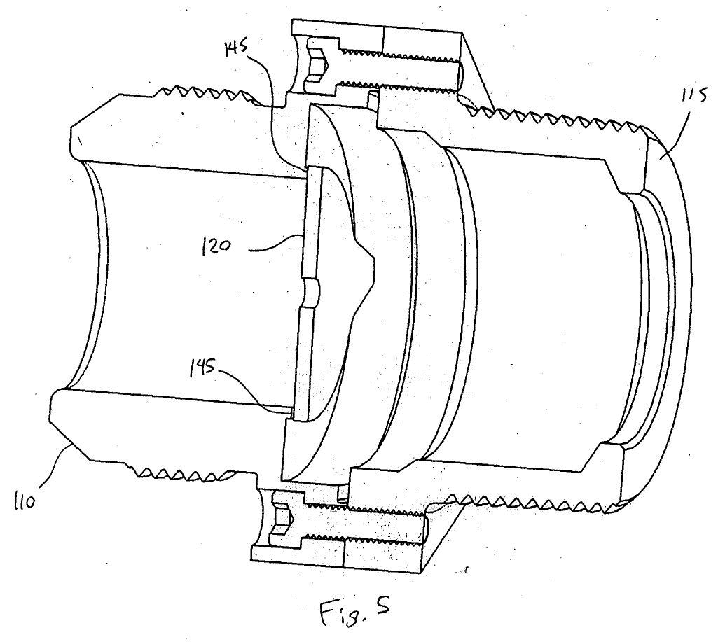

FIG. 5 is a cross section view of the check valve of the present invention with flow blocked by the flow blocking valve element. As depicted, the check valve includes the inlet side housing (110), the outlet side housing (115), and the flow blocking valve element (120). The flow blocking valve element (120) is shown pressed against the inlet annular shoulder (145), and a seal is formed between the flow blocking valve element (120) and the rim of the inlet annular shoulder (145). The valve of the present invention offers the advantage of a highly robust and reliable valve, that is inexpensive to manufacturing.

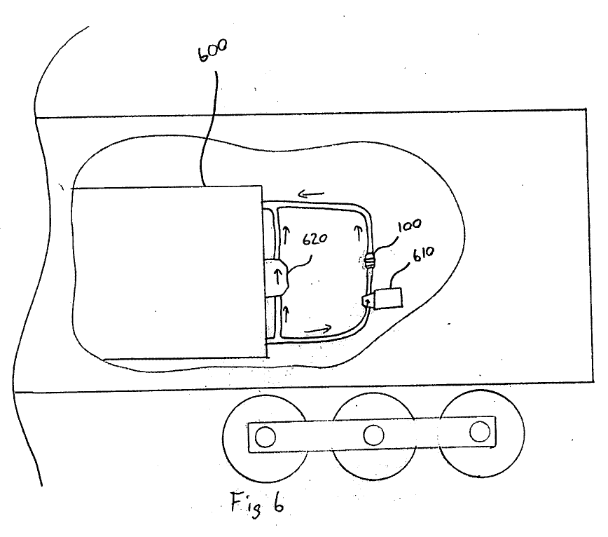

FIG. 6 is a schematic diagram of the check valve of the present invention integrated into a locomotive diesel engine lubrication system. As depicted, the system includes the locomotive diesel engine (600), the check valve (100), the electric prelube pump (610), the engine driven lube oil pump (620), and connection plumbing (630). The lubrication oil for the diesel engine (600) is pumped with an engine driven lube oil pump (620) during normal operation. Before the diesel engine is started on a cold start, the electric prelube pump (610) is operated to lubricate the engine. To prevent oil from the powerful engine driven lube oil pump (610) from spinning the electric prelube pump (610) in reverse once the diesel engine is running, a check valve is used to block the flow. The check valve has a reverse-flow orifice that allows a small amount of oil to flow in reverse through the check valve to slowly turn the electric prelube pump (620) so the bearings do not wear unevenly due to sitting in one position in the vibration environment of normal operation. The simple and robust design of the check valve of the present invention is well suited to the high reliability demands of the rail traction application described.

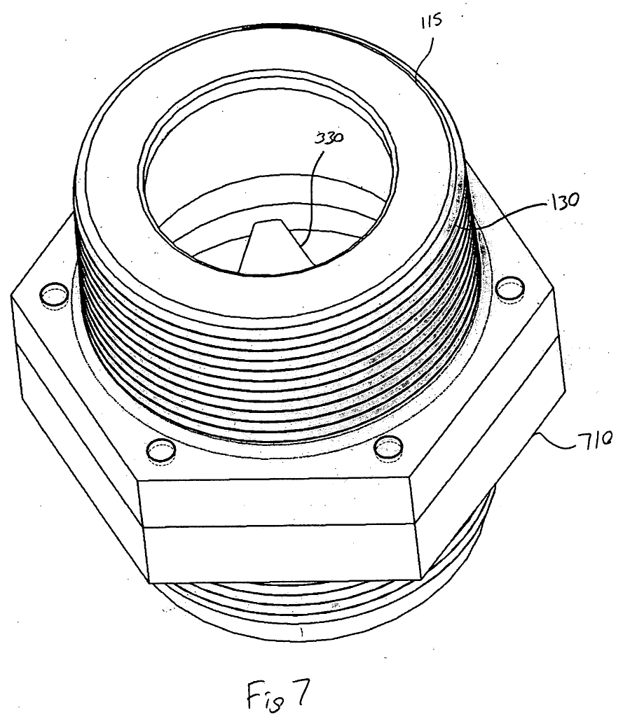

FIG. 7 is an external oblique view of the check valve of the present invention. As depicted the check valve includes outlet threads (130), a flow blocking valve element centering protrusion (330), the outlet-side housing (115), and a hexagonal shaped outer section (710). The hexagonal shaped outer section is used to hold the valve with a tool during installation.

While the invention has been described in the specification and illustrated in the drawings with reference to a main embodiment and certain variations, it will be understood that these embodiments are merely illustrative. Thus those skilled in the art may make various substitutions for elements of these embodiments, and various other changes, without departing from the scope of the invention as defined in the claims. Therefore, it is intended that the invention not be limited to the particular embodiment illustrated by the drawings and described in the specification as the best mode presently contemplated for carrying out this invention, but that the invention will include any embodiments falling within the spirit and scope of the appended claims.

We claim:

1. A check valve module, the module comprising:
an inlet-side housing with a inlet orifice;
an outlet-side housing with an outlet orifice;
a flow blocking valve element with centering protrusions;
an inlet annular shoulder;
an outlet annular shoulder;
a cylindrical valve element cavity.

2. The check valve module claimed in claim 1, wherein the flow blocking valve element with centering protrusions further comprises a reverse flow orifice configured to allow a small amount of flow in the reverse direction when the valve is closed.

3. The check valve module claimed in claim 1, wherein the flow blocking valve element is manufactured from plate steel cut into shape with a laser cutting system.

4. The check valve module claimed in claim 1, wherein the flow blocking valve element is manufactured from plate steel cut into shape with a laser cutting system and deburred with a tumbler deburring system.

5. The check valve module claimed in claim 1, wherein the flow blocking valve element is machined in a standard machining techniques and the tips of the valve element centering protrusions are rounded with a radius cutter.

6. The check valve module claimed in claim 1, wherein the number of centering protrusions on the flow blocking valve element is selected from the group comprising three protrusions, four protrusions, and five protrusions.

7. The check valve module claimed in claim 1, wherein the flow blocking valve element is comprised of a material selected from the group consisting of plastic, brass, aluminum, steel, iron, and titanium.

8. The check valve module claimed in claim 1, wherein the housing is comprised of a material selected from the group consisting of plastic, brass, aluminum, steel, iron, and titanium.

9. The check valve module claimed in claim 1, wherein the flow blocking valve element further comprises a central disc with centering protrusions extending from the central disc.

10. The check valve module claimed in claim 1, wherein the flow blocking valve element further comprises a central disc with centering protrusions uniformly disposed about the central disc.

11. A diesel engine lubrication system with a check valve for a locomotive, the system comprising:
an electric prelube pump;
a diesel engine with a engine driven lube oil pump;
a check valve comprising:
an inlet-side housing with a inlet orifice;
an outlet-side housing with a outlet orifice;
a flow blocking valve element with centering protrusions;
an inlet annular shoulder;
an outlet annular shoulder;
a cylindrical valve element cavity.
